(19) United States
(12) Patent Application Publication
(10) Pub. No.: US 2015/0180925 A1
(43) Pub. Date: Jun. 25, 2015

(54) PLAYING SYSTEM AND PLAYING METHOD

(71) Applicant: Alpha Networks Inc., Hsinchu (TW)

(72) Inventor: Jin-Fuu Lin, Hsinchu (TW)

(73) Assignee: Alpha Networks Inc., Hsinchu (TW)

(21) Appl. No.: 14/287,693

(22) Filed: May 27, 2014

(30) Foreign Application Priority Data
Dec. 19, 2013 (TW) 102147222

(51) Int. Cl. H04L 29/06; H04L 29/08

(52) U.S. Cl. CPC H04L 65/60; H04L 67/10; H04L 67/42

(57) ABSTRACT

A playing system and a plying method are provided. The playing system is selectively in communication with a portable device. The playing system includes a first playing device and a server. When the portable device is within a first detecting range corresponding to the first playing device, the first playing device is in communication with the portable device and issues a first playing request. The server is in communication with the first playing device for providing a multimedia stream. After the first playing request is received by the server, the multimedia stream is transmitted from the server to the first playing device, so that the multimedia stream is played by the first playing device.

This application claims the benefit of Taiwan Patent Application No. 102147222, filed Dec. 19, 2013, the subject matter of which is incorporated herein by reference.

### FIELD OF THE INVENTION

The present invention relates to a playing system and a playing method, and more particularly to a multimedia playing system and a multimedia playing method.

### BACKGROUND OF THE INVENTION

For watching movies or listening to music at homes, a variety of audio-visual devices are installed at homes of many people. While a user is watching a movie or listening to music, the user possibly moves from one position to another position. Under this circumstance, the playback of the movie or the music needs to be temporarily stopped.

For example, it is assumed that the living room, the bedroom and the kitchen have playing devices, and a user wants to listen to a song A all the time even if the user is in the living room first, and moves to a bedroom and a kitchen sequentially. In such case, the user has to turn off the playing device in the living room before moving to the bedroom. Then, the user has to turn on the playing device in the bedroom to play the song A. Similarly, when the user moves to the kitchen, the user has to turn off the playing device in the bedroom. When the user moves to the kitchen, the playing device in the kitchen is turned on to play the song A.

From the above discussions, the playing devices in different rooms are sequentially turned on and turned off by the user. Whenever the playing device is turned on, the user needs to select the song A again. If the time length of the song A is very long, the fast forward of the playback is employed to avoid listening to the song A from the beginning.

Similarly, the conventional method of playing a movie by the playing devices in different rooms in response to the movement of the user also has the above drawbacks. Therefore, there is a need of providing an improved playing system and an improved playing method in order to solve the above drawbacks.

### SUMMARY OF THE INVENTION

A first embodiment of the present invention provides a playing system for playing a multimedia stream. The playing system is selectively in communication with a portable device. The playing system includes a first playing device and a server. When the portable device is within a first detecting range corresponding to the first playing device, the first playing device is in communication with the portable device and issues a first playing request. The server is in communication with the first playing device for providing the multimedia stream. After the first playing request is received by the server, the multimedia stream is transmitted from the server to the first playing device, so that the multimedia stream is played by the first playing device.

A second embodiment of the present invention provides a playing system for playing a multimedia stream. The playing system includes a portable device, a first playing device, and a server. When the portable device is within a first detecting range corresponding to the first playing device, the first playing device is in communication with the portable device and issues a first playing request. The server is in communication with the first playing device for providing the multimedia stream. After the first playing request is received by the server, the multimedia stream is transmitted from the server to the first playing device, so that the multimedia stream is played by the first playing device.

A third embodiment of the present invention provides a playing method of a playing system for playing a multimedia stream. The playing system includes a first playing device, a server and a portable device. The first playing device has a first detecting range. The playing method includes the following steps. The server provides the multimedia stream. When the portable device is within the first detecting range corresponding to the first playing device, a communication between the first playing device and the portable device is established. After the communication between the first playing device and the portable device is established, the first playing device issues a first playing request. After the first playing request is received by the server, the multimedia stream is transmitted from the server to the first playing request. Afterwards, the multimedia stream is played by the first playing device.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 schematically illustrates the architecture of a playing system according to an embodiment of the present invention, in which a portable device is in a first detecting range;

FIG. 2 is a sequence diagram illustrating a playing method according to an embodiment of the present invention;

FIG. 3 schematically illustrates the architecture of the playing system according to the embodiment of the present invention, in which the portable device is moved to a second detecting range;

FIG. 4 is a sequence diagram illustrating an authorization procedure in which the first playing device is authorized by the server according to an embodiment of the present invention;

FIG. 5 is a sequence diagram illustrating an authorization procedure in which the portable device is authorized by the server according to an embodiment of the present invention; and

FIG. 6 is a sequence diagram illustrating an authorization procedure in which the first playing device is authorized through the portable device according to an embodiment of the present invention.

### DETAILED DESCRIPTION OF PREFERRED EMBODIMENTS

The present invention provides a playing system and a playing method for playing a multimedia stream. After the user moves from one position to another position, the movie or music originally played by one playing device is correspondingly played by another playing device. In other words, the multimedia stream can be dynamically played in response to the movement of the user. In this context, the multimedia streams indicate various types of video/audio contents.

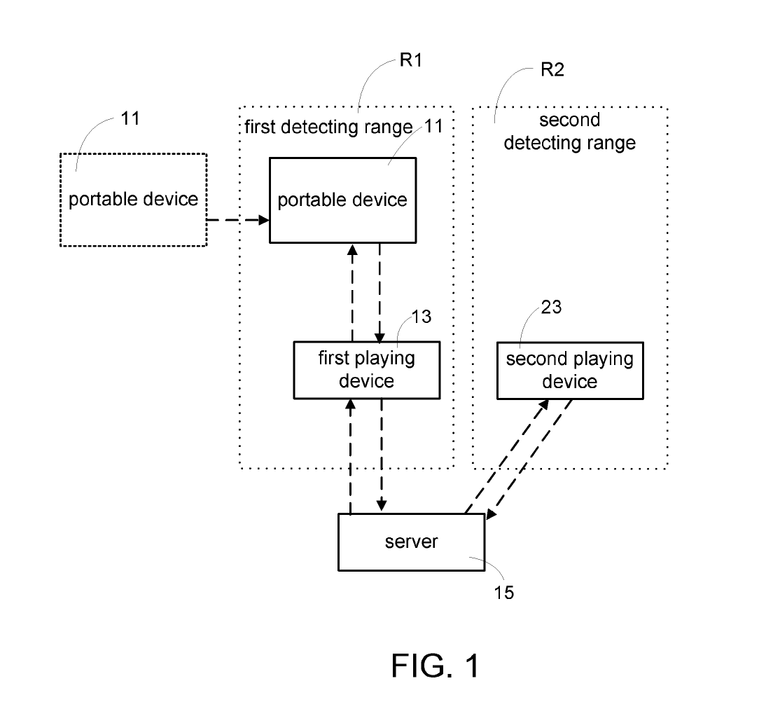

FIG. 1 schematically illustrates the architecture of a playing system according to an embodiment of the present invention, in which a portable device is in a first detecting range. As shown in FIG. 1, the playing system includes a first playing device 13, a second playing device 23, and a server 15. According to the position of a portable device 11, the first playing device 13 or the second playing device 23 of the playing system may be selectively in communication with the portable device 11. Moreover, various encryption technologies may be used with the communication between the server 15, the first playing device 13, the second playing device 23 and the portable device 11.

The server 15 may provide various multimedia streams to different playing devices. The multimedia stream may be previously stored in the server 15. Alternatively, the multimedia streams are transmitted from other devices to the server 15 through network connection.

The server 15 is in communication with the first playing device 13 and the second playing device 23 according to an Ethernet protocol or any other appropriate network transmission protocol. In addition, the first playing device 13, the second playing device 23 and the portable device 11 may be in communication with each other by a near field communication (NFC) technology, a Bluetooth pairing technology, a WiFi P2P technology or any other appropriate near-distance transmission technology.

The way of judging whether the portable device 11 is within the detecting range corresponding to the first playing device 13 or the second playing device 23 is adopted according to the type of the near-distance transmission technology. For example, the near field communication (NFC) technology may be employed to judge whether the portable device 11 is within a first detecting range R1 corresponding to the first playing device 13. In addition, the Bluetooth pairing technology may be employed to judge whether the portable device 11 is within a second detecting range R2 corresponding to the second playing device 23.

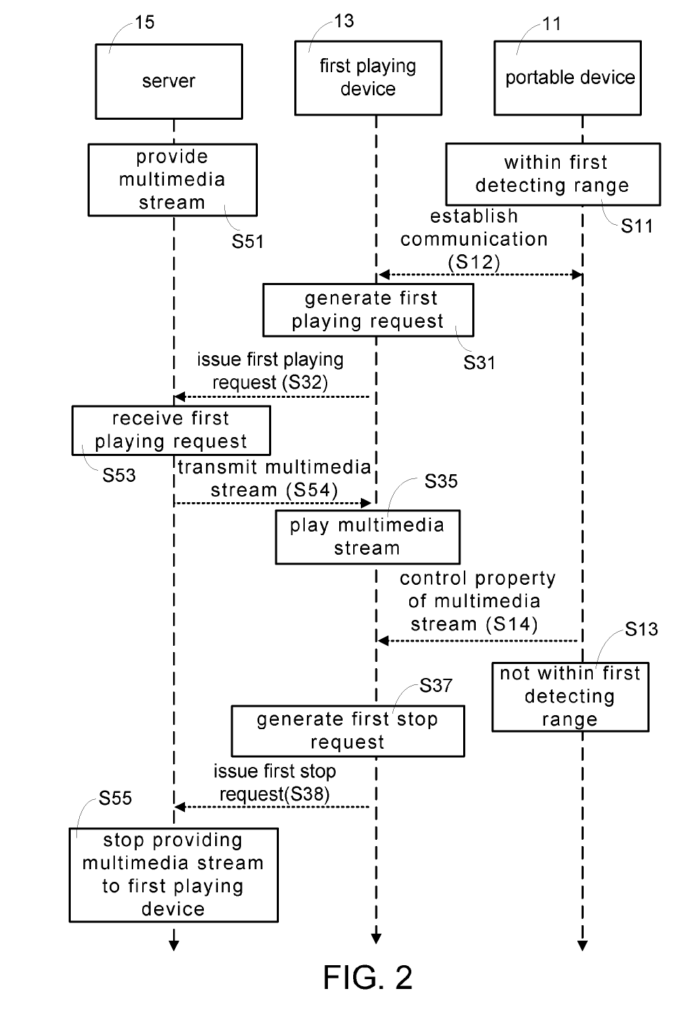

In this embodiment, the first playing device 13 realizes that the portable device 11 is within the first detecting range R1 according to the near-distance transmission technology. Consequently, a multimedia playing function of the first playing device 13 will be enabled by the playing method of the present invention. The operations of the portable device 11, the first playing device 13 and the server 15 will be illustrated with reference to FIG. 2.

After the first playing device 13 or the second playing device 23 is in communication with the portable device 11, the multimedia stream may be received from the server 15 and played by the first playing device 13 and/or the second playing device 23. Moreover, while the multimedia stream is played by the first playing device 13 or the second playing device 23, the portable device 11 may be served as a remote controller for controlling playback of the multimedia stream. For example, while the multimedia stream is played by the first playing device 13 and/or the second playing device 23, a sound volume adjustment property or a list selection property may be controlled by the portable device 11.

It is noted that various multimedia playing devices for playing multimedia streams may be used as the first playing device 13 and/or the second playing device 23. For example, the first playing device 13 and/or the second playing device 23 may be intelligent televisions, BD players or acoustic systems etc. An example of the portable device 11 includes but is not limited to a mobile phone, a tablet computer or a personal digital assist. The first playing device 13 is corresponding to the first detecting range R1. The second playing device 23 is corresponding to the second detecting range R2. For example, the first detecting range R1 is a bedroom, and the second detecting range R2 is a living room.

When the portable device 11 is moved to be within the first detecting range R1, the first playing device 13 is capable of detecting existence of the portable device 11 thus starts playing the multimedia stream. Similarly, when the portable device 11 is moved to be within the second detecting range R2, the second playing device 23 is capable of detecting existence of the portable device 11 thus starts playing the multimedia stream. Consequently, the user can listen or watch the multimedia stream no matter the user is in the bedroom (the detecting range R1) or the living room (the detecting range R2).

FIG. 2 is a sequence diagram illustrating a playing method according to an embodiment of the present invention. In FIG. 2, the dotted arrows indicate the operating sequence. The directions of the dotted arrows indicate the operating relationships between associated devices.

Firstly, a multimedia stream is continuously provided by the server 15 (Step S51). The server 15 and the first playing device 13 are in communication to each other through network connection. Then, the portable device 11 is moved to a position within the first detecting range R1 corresponding to the first playing device 13 (Step S11). The first playing device 13 detects existence of the portable device 11 through the near-distance transmission technology. Consequently, the communication between the first playing device 13 and the portable device 11 is established (Step S12). The communication between the first playing device 13 and the portable device 11 may be based on the near-distance transmission technology or network connection.

After the communication between the first playing device 13 and the portable device 11 is established, the first playing device 13 generates a first playing request (Step S31) and issues the first playing request (Step S32). The first playing request is then transmitted through the network connection between the server 15 and the first playing device 13. After the first playing request is received by the server 15 (Step S53), the multimedia stream is transmitted from the server 15 to the first playing device 13 (Step S54). Then, the multimedia stream is played by the first playing device 13 (Step S35). During the period of playing the multimedia stream by the first playing device 13, the property of the multimedia stream to be played may be controlled by the portable device 11 (Step S14).

It should be noted that, the multimedia stream transmitted to the first playing device 13 may not be a whole song nor a whole movie. Instead, the multimedia stream actually transmitted to the first playing device 13 may be partial or whole of the song or movie. Furthermore, the first playing device 13 does not need to wait until the multimedia stream is completely received. That is, the first playing device 13 may receive and play the multimedia stream in real time.

After the portable device 11 is departed from the first detecting range R1 (Step S13), the first playing device 13 generates a first stop request (Step S37) and issues the first stop request to the server 15 (Step S38). After the first stop request is received by the server 15, the server 15 stops providing the multimedia stream to the first playing device 13 (Step S55).

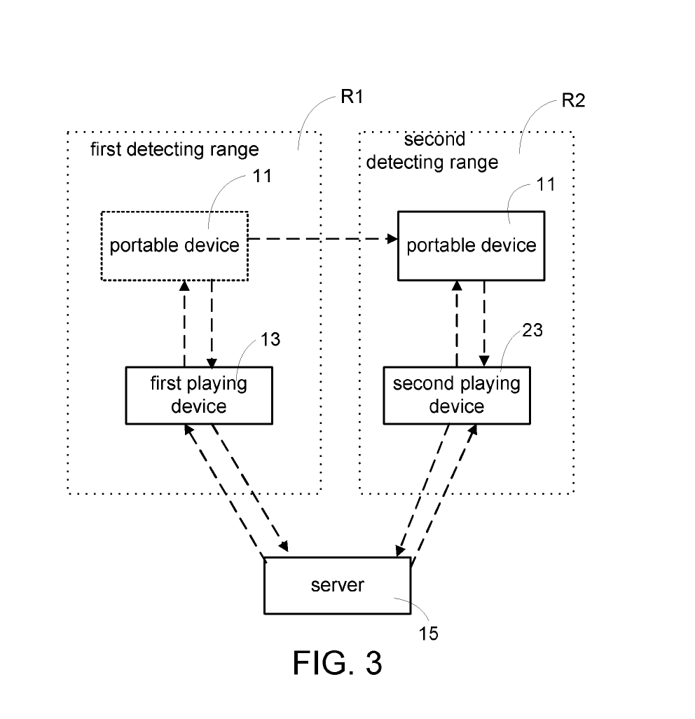

FIG. 3 schematically illustrates the architecture of the playing system according to the embodiment of the present invention, in which the portable device is moved to a second detecting range. As shown in FIG. 3, the portable device 11 is moved from the first detecting range R1 to the second detecting range R2.

After the first playing device 13 judges that the portable device 11 is not within the first detecting range R1, it is not necessary to use the first playing device 13 to play the multimedia stream. Consequently, the first playing device 13 issues a first stop request to the server 15. After the first stop request is received by the server 15, the server 15 stops providing the multimedia stream to the first playing device 13.

Originally, the portable device 11 is not within the second detecting range R2 corresponding to the second playing device 23. When the portable device 11 is moved to a position within the second detecting range R2, the second playing device 23 starts to be in communication with the portable device 11 and issues the a second playing request to the server 15. After the second playing request is received by the server 15, the server 15 realizes that the portable device 11 is already moved from the first detecting range R1 to the second detecting range R2. Under this circumstance, the multimedia stream is transferred from the server 15 to the second playing device 23, and thus the multimedia stream is played by the second playing device 23.

In some embodiments, after the first stop request is received by the server 15, the multimedia stream played by the first playing device 13 is not immediately stopped. For example, at the time when the portable device 11 is departed from the first detecting range R1, the multimedia stream is still played by the first playing device 13 for a while. After the portable device 11 is moved to the position within the second detecting range R2 and the multimedia stream has played by the second playing device 23 for a certain time period, the playback of the first playing device 13 is stopped. Consequently, while the user is moved from one position to another position, the multimedia stream (e.g. music) can be smoothly listened by the user.

In other words, the time point of stopping playing the multimedia stream by the first playing device 13 may be later than the time point of starting playing the multimedia stream by the second playing device 23. The time points of starting or stopping the playback of different playing devices may be previously determined according to the systematic settings or the user's settings.

From the above discussions, the server 15 may notice and realize the position change of the portable device 11 through the playing request and/or stop request issued by first playing device 13 and the second playing device 23. Consequently, the multimedia stream is transmitted to corresponding destination playing device by the server 15 according to the playing status of the multimedia stream.

For example, if the playback progress of the multimedia stream having been played by the first playing device 13 is 5′10″, after the portable device 11 is moved from the first detecting range R1 to the second detecting range R2, the segment of the multimedia stream after this playback progress will be transmitted from the server 15 to the second playing device 23 and played by the second playing device 23.

In the above embodiment, the playing system includes two playing devices and one portable device. It is noted that the playing method of the present invention may be applied to the playing system including plural playing devices and/or plural portable devices.

Moreover, after the authorization procedures of the playing devices and the portable device are performed, the playing system can verify the user identity. For example, the authorizing processes may assure that only the members of the family are allowed to control the playing devices to play the multimedia stream from the server 15. If the portable device 11 does not belong to the user, the portable device 11 fails to be successfully authorized. Under this circumstance, the portable device 11 is unable to control the playback of the multimedia stream.

After a recognition certificate is acquired by both of the first playing device 13 and the portable device 11, if the first playing device 13 judges that the portable device 11 is within the first detecting range R1, the first playing device 13 may verify the user identity according to the recognition certificate. After the user identity is verified, the first playing device 13 issues the first playing request to the server 15.

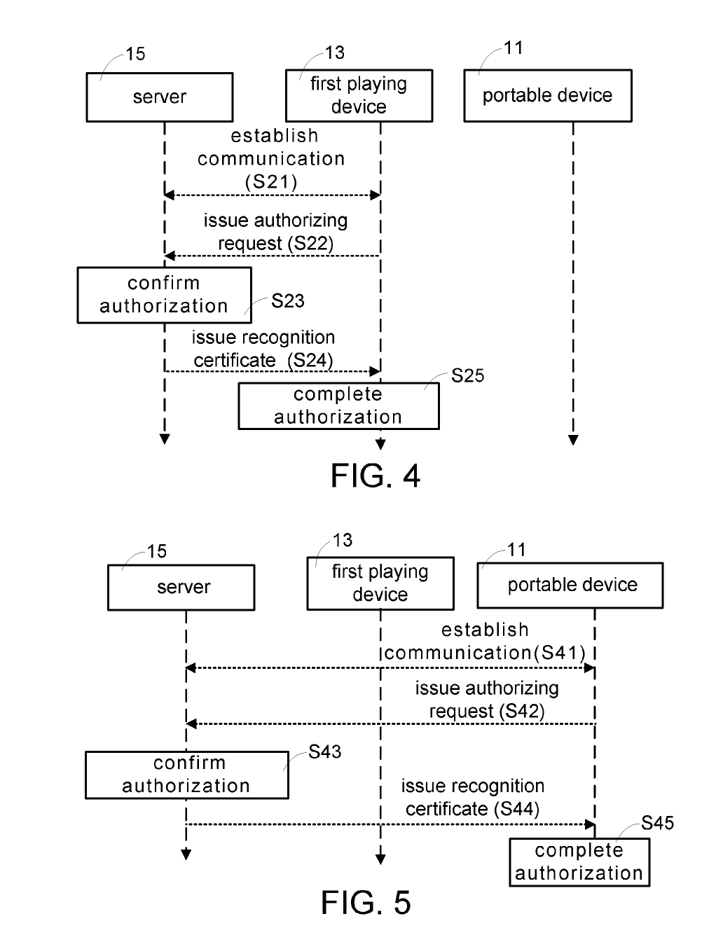

FIG. 4 is a sequence diagram illustrating an authorization procedure in which the first playing device is authorized by the server according to an embodiment of the present invention. Firstly, the communication between the server 15 and the first playing device 13 is established (Step S21). Then, the first playing device 13 issues an authorizing request (Step S22). If the server 15 confirms that the first playing device 13 is successfully authorized (Step S23), the server 15 issues a recognition certificate to the first playing device 13 (Step S24). Then, the authorization procedure of the first playing device 13 is finished (Step S25).

In practical applications, the authorization procedure may be activated by the playing device and/or the server 15. For example, in an embodiment, the first playing device 13 actively issues the authorizing request to the server 15. Alternatively, in some other embodiments, the server 15 may send a broadcast to inquire whether any neighboring playing device needs to be authorized. If the first playing device 13 needs to be authorized, the first playing device 13 may issue the authorizing request to the server 15 to respond to the broadcast from the server 15.

FIG. 5 is a sequence diagram illustrating an authorization procedure in which the portable device is authorized by the server according to an embodiment of the present invention. Firstly, the communication between the server 15 and the portable device 11 is established (Step S41). Then, the portable device 11 issues an authorizing request (Step S42). If the server 15 confirms that the portable device 11 is authorized (Step S43), the server 15 issues a recognition certificate to the portable device 11 (Step S44). Then, the authorization procedure of the portable device 11 is finished (Step S45).

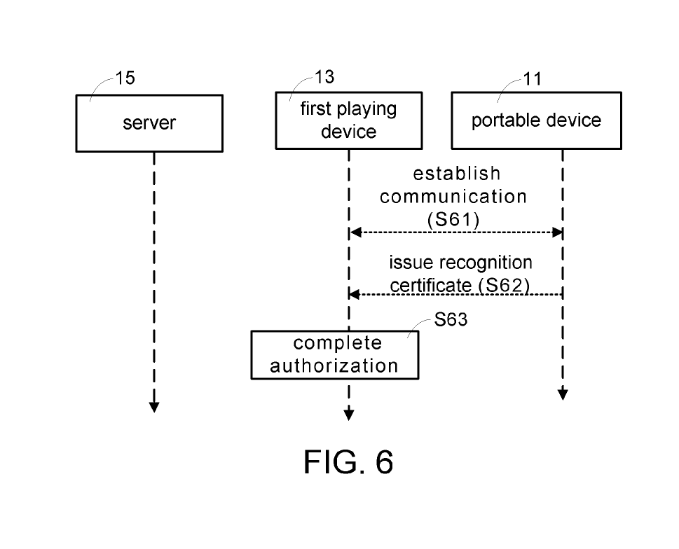

FIG. 6 is a sequence diagram illustrating an authorization procedure in which the first playing device is authorized through the portable device according to an embodiment of the present invention. After the portable device 11 is authorized to acquire the recognition certificate, the authorization procedure of the first playing device 13 may be implemented through the portable device 11.

Firstly, the communication between the first playing device 13 and the portable device 11 is established (Step S61). Then, the recognition certificate is transmitted from the portable device 11 to the first playing device 13 (Step S62). Meanwhile, the authorization procedure of the first playing device 13 is finished (Step S63).

From the above descriptions, the present invention provides a playing system and a playing method for playing a multimedia stream. The playing system and the playing method play the multimedia stream in a flexible manner. After the user moves from one position to another position, the movie or music stream originally played by one playing device is correspondingly adjusted to be played by another playing device. In other words, the multimedia stream can be dynamically played in response to the movement of the user. By using the playing method of the present invention, the flexibility of operating the playing system is enhanced.

Those skilled in the art would appreciate that various logic blocks, modules, circuits, and method steps in the above embodiments may be implemented by electronic hardware, computer software, and the combination there of. The connections in the implementation process, such as linking, coupling, electrical connection, or others are used to illustrate that when implementing the logic blocks, module, circuits, or method steps, different manners such as wired electronic signal, wireless electromagnet signal, and light signal can be used for direct or indirect transmission and switching of signal, data, or control information. Therefore, terms in the disclosure are not understood as limitation for implementing the connections. Other connections which are not described in the disclosure are also within the scope of the disclosure.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A playing system for playing a multimedia stream, the playing system being selectively in communication with a portable device, the playing system comprising:
a first playing device, wherein when the portable device is within a first detecting range corresponding to the first playing device, the first playing device is in communication with the portable device and issues a first playing request; and
a server, in communication with the first playing device, for providing the multimedia stream, wherein after the first playing request is received by the server, the multimedia stream is transmitted from the server to the first playing device, so that the multimedia stream is played by the first playing device.

2. The playing system as claimed in claim 1, further comprising a second playing device in communication with the server, wherein when the portable device is within a second detecting range corresponding to the second playing device, the second playing device is in communication with the portable device and issues a second playing request to the server, wherein after the second playing request is received by the server, the multimedia stream is transmitted from the server to the second playing device, so that the multimedia stream is played by the second playing device.

3. The playing system as claimed in claim 2, wherein when the portable device is not within the first detecting range, the first playing device issues a first stop request to the server, wherein the server stops providing the multimedia stream to the first playing device after receiving the first stop request.

4. The playing system as claimed in claim 1, wherein the server identifies the portable device and the first playing device through an authorization procedure.

5. The playing system as claimed in claim 1, wherein the portable device and the first playing device are in communication with each other by a near-distance transmission technology.

6. The playing system as claimed in claim 5, wherein the near-distance transmission technology is a Bluetooth pairing technology, a WiFi P2P technology or a near field communication (hereinafter, NFC) technology.

7. The playing system as claimed in claim 1, wherein while the multimedia stream is played by the first playing device, a sound volume adjustment property or a list selection property is controllable by the portable device.

8. A playing system for playing a multimedia stream, the playing system comprising:
a portable device;
a first playing device, wherein when the portable device is within a first detecting range corresponding to the first playing device, the first playing device is in communication with the portable device and issues a first playing request; and
a server, in communication with the first playing device, for providing the multimedia stream, wherein the server transmits the multimedia stream to the first playing device after receiving the first playing request, so that the multimedia stream is played by the first playing device.

9. The playing system as claimed in claim 8, further comprising a second playing device in communication with the server, wherein when the portable device is within a second detecting range corresponding to the second playing device, the second playing device is in communication with the portable device and issues a second playing request to the server, wherein the server transmits the multimedia stream to the second playing device after receiving the second playing request, so that the multimedia stream is played by the second playing device.

10. The playing system as claimed in claim 9, wherein when the portable device is not within the first detecting range, the first playing device issues a first stop request to the server, wherein the server stops providing the multimedia stream to the first playing device after receiving the first stop request.

11. A playing method of a playing system for playing a multimedia stream, the playing system comprising a first playing device, a server and a portable device, wherein the first playing device is corresponding to a first detecting range, the playing method comprising steps of:
allowing the server to provide the multimedia stream;
establishing a communication between the first playing device and the portable device when the portable device is within the first detecting range;
issuing a first playing request from the first playing device after the communication between the first playing device and the portable device is established;
transmitting the multimedia stream from the server to the first playing request after the first playing request is received by the server; and
playing the multimedia stream by the first playing device.

12. The playing method as claimed in claim 11, wherein the playing system further comprises a second playing device, and the second playing device is corresponding to a second detecting range, wherein the playing method further comprises steps of:
establishing a communication between the second playing device and the portable device when the portable device is within the second detecting range;
issuing a second playing request from the second playing device after the communication between the second playing device and the portable device is established;
transmitting the multimedia stream from the server to the second playing request after the second playing request is received by the server; and
playing the multimedia stream by the second playing device.

13. The playing method as claimed in claim 12, further comprising steps of:
if the first playing device is not within the first detecting range, the first playing device issuing a first stop request to the server; and
stopping transmitting the multimedia stream from the server to the first playing device after the first stop request is received by the server.

14. The playing method as claimed in claim 11, further comprising a step of the server identifying the portable device and the first playing device through an authorization procedure.
